(19) United States
(12) Patent Application Publication
(10) Pub. No.: US 2015/0277037 A1
(43) Pub. Date: Oct. 1, 2015

(54) OPTICAL WAVEGUIDE, PHOTOELECTRIC HYBRID BOARD AND METHOD OF MANUFACTURING OPTICAL WAVEGUIDE

(71) Applicant: FUJITSU LIMITED, Kawasaki-shi (JP)

(72) Inventor: Takahiro OOI, Kawasaki (JP)

(21) Appl. No.: 14/636,586

(22) Filed: Mar. 3, 2015

(30) Foreign Application Priority Data
Mar. 31, 2014 (JP) 2014-074079

(51) Int. Cl. G02B 6/12; G02B 6/136

(52) U.S. Cl. CPC G02B 6/12; G02B 6/136; G02B 2006/12173; G02B 2006/12176

(57) ABSTRACT

An optical waveguide includes: a core through which light propagates; a first cladding covering a periphery of the core; and a second cladding optically closing part of the core in a direction perpendicular to a direction of the propagation of the light. And a photoelectric hybrid board includes: a board including an electrical part and interconnections; an electrical-to-optical conversion device mounted on the board, and configured to convert an electrical signal received from the electrical part into an optical signal; an optical waveguide mounted on the board, and configured to guide the optical signal outputted from the electrical-to-optical conversion device; an optical-to-electrical conversion device mounted on the board, and configured to convert the optical signal outputted from the optical waveguide into an electrical signal.

### CROSS-REFERENCE TO RELATED APPLICATION

This application is based upon and claims the benefit of priority of the prior Japanese Patent Application No. 2014-074079, filed on Mar. 31, 2014, the entire contents of which are incorporated herein by reference.

### FIELD

The embodiment discussed herein is related to an optical waveguide, a photoelectric hybrid board, and a method of manufacturing an optical waveguide.

### BACKGROUND

A stepped index-type optical waveguide includes a core with a uniform refractive index. Accordingly, various modes of light emitted from a light source with a certain numerical aperture (NA) propagate through the core in their various modes. A higher-order mode of light reaches a light receiving side while repeatedly reflected by the interface between the core and cladding a larger number of times. A lower-order mode of light reaches the light receiving side while repeatedly reflected by the interfaces a smaller number of times.

There is, for example, a waveguide having a structure in which cores are stacked with a spacer interposed in between. The spacer has the same property as the cladding. In addition, there is a technique in which waveguides are disposed in parallel and interfaces between cores and claddings are designed to have a certain refractive index profile. Furthermore, there is a technique for forming a core by stacking multiple layers in which low electron density portions are disposed between high electron density portions.

However, a larger number of reflections lengthen an optical path length of light which propagates through the core. Thus, the optical path length of a higher-order mode of light is longer than that of a lower-order mode of light. As a result, a higher-order mode of light arrives at the light receiving side later than a lower-order mode of light. Accordingly, when the light receiving side converts received signal light into an electrical signal, jitters occur. The occurrence of jitters raises a problem of deterioration in signal quality.

The followings are reference documents.

### [Document 1] Japanese Laid-open Patent Publication No. 2006-023385,

### [Document 2] Japanese Laid-open Patent Publication No. 2012-068631 and

### [Document 3] Japanese Laid-open Patent Publication No. 2011-253070.

### SUMMARY

According to an aspect of the invention, an apparatus includes An optical waveguide includes: a core through which light propagates; a first cladding covering a periphery of the core; and a second cladding optically closing part of the core in a direction perpendicular to a direction of the propagation of the light.

According to an aspect of the invention, a photoelectric hybrid board includes: a board including an electrical part and interconnections; an electrical-to-optical conversion device mounted on the board, and configured to convert an electrical signal received from the electrical part into an optical signal; an optical waveguide mounted on the board, and configured to guide the optical signal outputted from the electrical-to-optical conversion device; an optical-to-electrical conversion device mounted on the board, and configured to convert the optical signal outputted from the optical waveguide into an electrical signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first example of an optical waveguide according to an embodiment;

FIG. 2 is a diagram illustrating an end surface of the optical waveguide illustrated in FIG. 1;

FIG. 3 is a diagram illustrating a second example of the optical waveguide according to an embodiment;

FIG. 4 is a diagram illustrating a third example of the optical waveguide according to an embodiment;

FIG. 5 is a diagram illustrating an example of a method of manufacturing an optical waveguide according to an embodiment; and

FIG. 6 is a diagram illustrating an example of a photoelectric hybrid board according to an embodiment.

### DESCRIPTION OF EMBODIMENT

Hereinafter, referring to the accompanying drawings, embodiments of an optical waveguide, a photoelectric hybrid board, a printed wiring board unit, and a method of manufacturing an optical waveguide are described in detail. In the following descriptions of the embodiments, the same components are denoted by the same reference symbols, and duplicated descriptions thereof are omitted.

First Example of Optical Waveguide

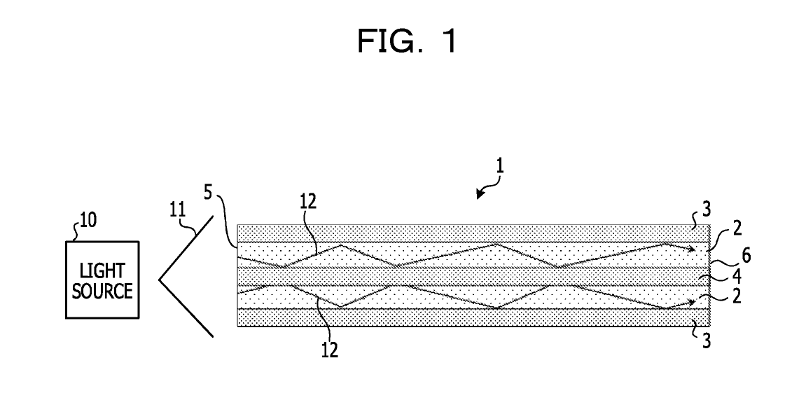

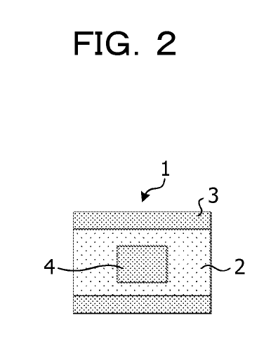

FIG. 1 is a diagram illustrating a first example of an optical waveguide according to an embodiment. FIG. 2 is a diagram illustrating an end surface of the optical waveguide illustrated in FIG. 1. As illustrated in FIGS. 1 and 2, an optical waveguide 1 is formed by: covering the periphery of a core 2 through which light propagates with a first cladding 3 for confining the light in the core 2; and optically closing a central portion of the core 2 in the direction perpendicular to the direction of the propagation of the light with a second cladding 4. The center of a light source 10 is set in alignment with the center of the optical waveguide 1. In the optical waveguide 1, the second cladding 4 does not allow light to pass through. Accordingly, light emitted from the center of the light source 10 does not propagate through the optical waveguide 1. As a result, a low-order mode of light reaching the light receiving side is suppressed.

Signal light 11 emitted from the light source 10 with a certain numerical aperture enters the core 2 through a light incident-side end surface 5 of the optical waveguide 1, travels in a longitudinal direction of the optical waveguide 1, that is in an extending direction of the core 2, reaches a light outgoing-side end surface 6 of the optical waveguide 1, and goes out of the optical waveguide 1 through the light outgoing-side end surface 6. Accordingly, the direction of the propagation of the light coincides with the longitudinal direction of the optical waveguide 1, and the direction perpendicular to the longitudinal direction of the optical waveguide 1 coincides with a direction perpendicular to the direction of the propagation of the light. Zigzagging arrows in FIG. 1 represent signal light 12 which travels while repeatedly reflected by the interface between the core 2 and the first cladding 3.

The core 2, the first cladding 3 and the second cladding 4 may be formed from a resin such as an epoxy-based resin. The refractive index of the core 2 is higher than those of the first cladding 3 and the second cladding 4. The signal light 12 incident on the core 2 travels in the core 2 while totally reflected repeatedly by the interface between the core 2 and the first cladding 3 and between the core 2 and the second cladding 4. The optical waveguide 1 may be a stepped index type optical wave guide in which a refractive index profile is uniform in the core 2.

Lengths of the core 2 and the first cladding 3, namely, a length of the optical waveguide 1 is determined depending on an apparatus in which the optical waveguide 1 is used. A diameter of the core 2 is smaller than that of the signal light 11 emitted from the light source 10 with a certain numerical aperture. Although not specifically restricted, the diameter of the core 2 may be, for example, in a range of approximately 9 μm to 50 μm. In such case, coupling loss involved in coupling the core 2 to a single-mode fiber or a multi-mode fiber may be reduced. Although not specifically restricted, a diameter of the first cladding 3 may be, for example, in a range of approximately 5 μm to 50 μm. In such case, light may be confined in the core 2.

A length of the second cladding 4 may be equal to that of the core 2, for example. In other words, the second cladding 4 may be provided along the full length of the optical waveguide 1. The second cladding 4 has a diameter which enables reduction of the propagation of signal light whose optical path includes a smaller number of reflections by the interface between the core 2 and the first cladding 3 if no second cladding 4 is provided, namely a low-order mode of signal light. Accordingly, propagation of the lower-order mode of signal light through the core 2 may be reduced.

Since the central portion of the core 2 is optically closed by the second cladding 4, the optical waveguide 1 illustrated in FIG. 1 reduces the lower-order mode of signal light propagating through the core 2 and reaching the light outgoing-side end surface 6. A higher-order mode of signal light, meanwhile, propagates through the core 2, reaches the light outgoing-side end surface 6, and is emitted through the light outgoing-side end surface 6. Accordingly, the light receiving side receives the higher-order mode of signal light emitted from the optical waveguide 1, and converts the higher-order mode of signal light into an electrical signal. Accordingly, the occurrence of jitters may be reduced. The reduction of the occurrence of the jitters enables deterioration in the signal quality to be suppressed.

Second Example of Optical Waveguide

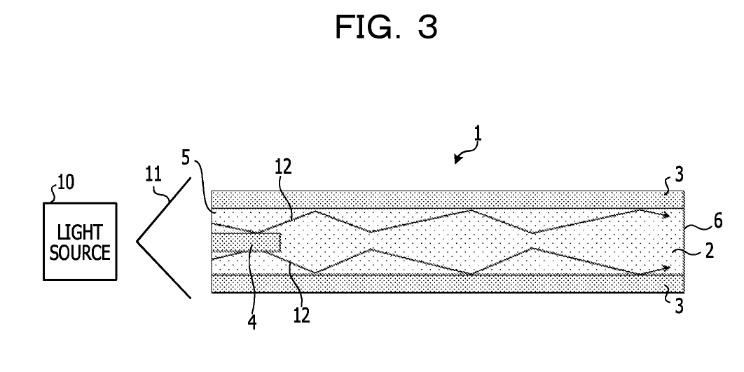

FIG. 3 is a diagram illustrating a second example of the optical waveguide according to the embodiment. In the second example, as illustrated in FIG. 3, the second cladding 4 is provided close to the light incident-side end surface 5 of the optical waveguide 1, while no second cladding 4 is provided close to the light outgoing-side end surface 6.

The second cladding 4 has a length which enables reduction of the propagation of the lower-order mode of signal light whose optical path includes a smaller number of reflections by the interface between the core 2 and the first cladding 3 if no second cladding 4 is provided. The rest of the configuration of the second example is the same as the configuration of the foregoing first example. Duplicated explanations, therefore, are omitted.

In the case where the central portion of the core 2 close to the light incident-side end surface 5 is optically closed by the second cladding 4, the optical waveguide 1 illustrated in FIG. 3 also reduces the lower-order mode of signal light propagating through the core 2 and reaching the light outgoing-side end surface 6. Accordingly, the light receiving side receives the higher-order mode of signal light emitted from the optical waveguide 1, and converts the higher-order mode of signal light into an electrical signal. Thus, the occurrence of jitters may be reduced.

Third Example of Optical Waveguide

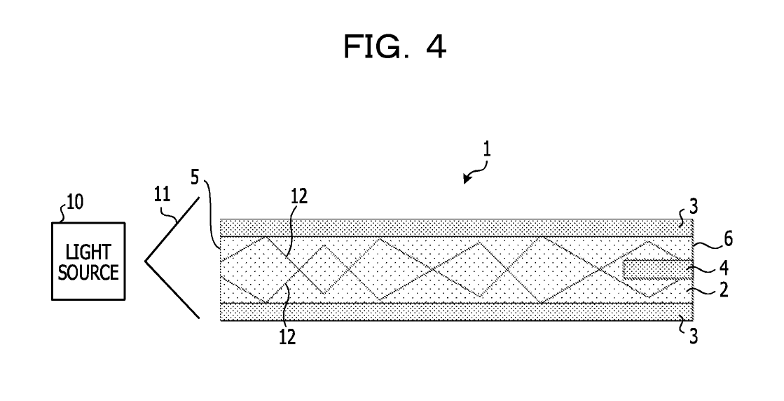

FIG. 4 is a diagram illustrating a third example of the optical waveguide according to the embodiment. In the third example, as illustrated in FIG. 4, the second cladding 4 is provided close to the light outgoing-side end surface 6 of the optical waveguide 1, while no second cladding 4 is provided close to the light incident-side end surface 5.

The second cladding 4 has a length which enables reduction of the propagation of the lower-order mode of signal light whose optical path includes a smaller number of reflections by the interface between the core 2 and the first cladding 3 if no second cladding 4 is provided. Thus, the lower-order mode of signal light propagating through the core 2 may be inhibited from reaching the light outgoing-side end surface 6. The rest of the configuration of the third example is the same as the configuration of the foregoing first example. Duplicated explanations, therefore, are omitted.

Since the central portion of the core 2 close to the light outgoing-side end surface 6 is optically closed by the second cladding 4, the optical waveguide 1 illustrated in FIG. 4 also reduces the lower-order mode of signal light being emitted through the light outgoing-side end surface 6. Accordingly, the light receiving side receives the higher-order mode of signal light emitted from the optical waveguide 1, and converts the higher-order mode of signal light into an electrical signal. Thus, the occurrence of jitters may be reduced.

Example of Method of Manufacturing Optical Waveguide

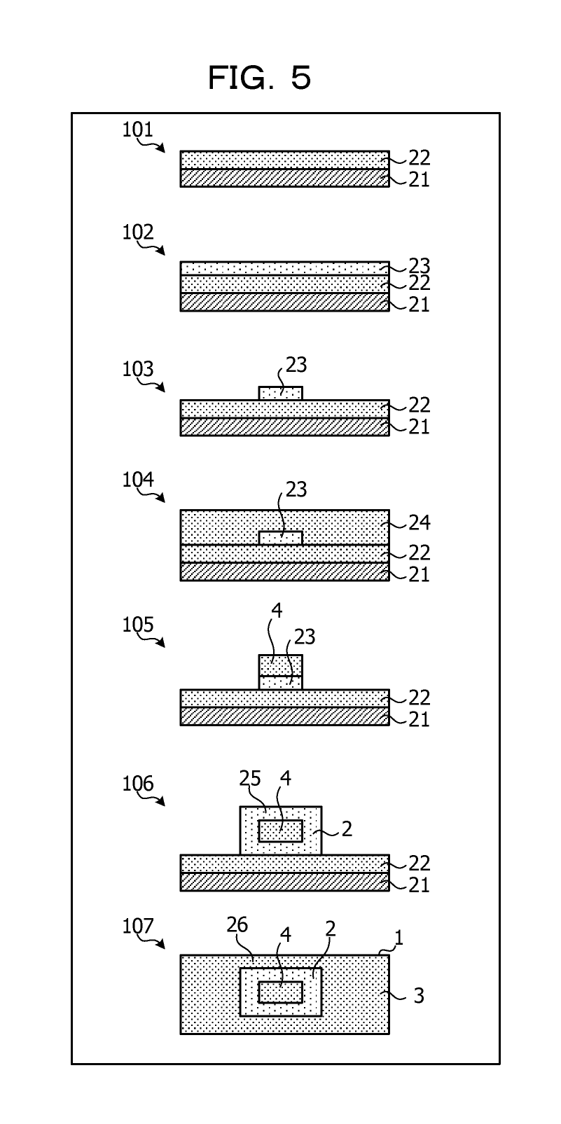

FIG. 5 is a diagram illustrating an example of a method of manufacturing an optical waveguide according to the embodiment. First, in step S101, the operator applies a first layer 22 on a substrate 21, such as a silicon wafer or a glass substrate, by using a spin coater, for example. The first layer 22 becomes part of the first cladding 3.

Subsequently, in step S102, the operator applies a second layer 23 above the substrate 21 by using a spin coater, for example. The second layer 23 becomes part of the core 2.

Thereafter, in step S103, the operator applies a photoresist, although not illustrated, above the substrate 21 by using a spin coater, for example; exposes and develops the photoresist by using a photomask, although not illustrated; and thereby forms a resist mask, although not illustrated, on the second layer 23. The operator removes part not to be used from the second layer 23, for example by etching, such as dry etching, using this resist mask as a mask, and thereby leaves part of the second layer 23, which becomes part of the core 2, on the first layer 22. In this step S103, the second layer 23 is formed into the shape of the core 2.

Afterward, in step S104, the operator applies a third layer 24 above the substrate 21 by using a spin coater, for example. The third layer 24 becomes the second cladding 4.

Subsequently, in step S105, the operator applies a photoresist, although not illustrated, above the substrate 21 by using a spin coater, for example; exposes and develops the photoresist by using a photomask, although not illustrated; and thereby forms a resist mask, although not illustrated, on the third layer 24. The operator removes part not to be used from the third layer 24, for example by etching, such as dry etching, using this resist mask as a mask, and thereby forms the second cladding 4 on at least part of the second layer 23 which becomes part of the core 2.

Thereafter, in step S106, the operator applies a fourth layer 25, which becomes part of the core 2, above the substrate 21 by using a spin coater, for example. Afterward, the operator applies a photoresist, although not illustrated, above the substrate 21 by using a spin coater, for example; exposes and develops the photoresist by using a photomask, although not illustrated; and thereby forms a resist mask, although not illustrated, on the fourth layer 25. The operator removes part not to be used from the fourth layer 25, for example by etching, such as dry etching, using this resist mask as a mask, and leaves part of the fourth layer 25, which becomes part of the core 2 covering the second cladding 4. In this step, part of the fourth layer 25 is also left on exposed part of the second layer 23, for example in the case where, as illustrated in FIG. 3, the second cladding 4 is provided close to the light incident-side end surface 5, or for example in the case where, as illustrated in FIG. 4, the second cladding 4 is provided close to the light outgoing-side end surface 6. The part which is formed in this step S106 to become part of the core 2, and the part which is formed in the foregoing step S103 to become part of the core 2 form the core 2 in a way that the core 2 surrounds the second cladding 4.

Afterward, in step S107, the operator applies a fifth layer 26, which becomes part of the first cladding 3, above the substrate 21 by using a spin coater, for example. The part which is formed in this step S107 to become part of the first cladding 3, and the part which is formed in the foregoing step S101 to become part of the first cladding 3 form the first cladding 3 in a way that the first cladding 3 surrounds the core 2. Subsequently, the operator detaches the optical waveguide 1 from the substrate 21. Accordingly, the optical waveguide 1 is completed.

The method of manufacturing an optical waveguide illustrated in FIG. 5 enables the optical waveguides 1 illustrated in FIGS. 1 to 4 to be manufactured without using a specialized apparatus, and without employing complicated steps.

Example of Photoelectric Hybrid Board and Example of Printed Wiring Board Unit

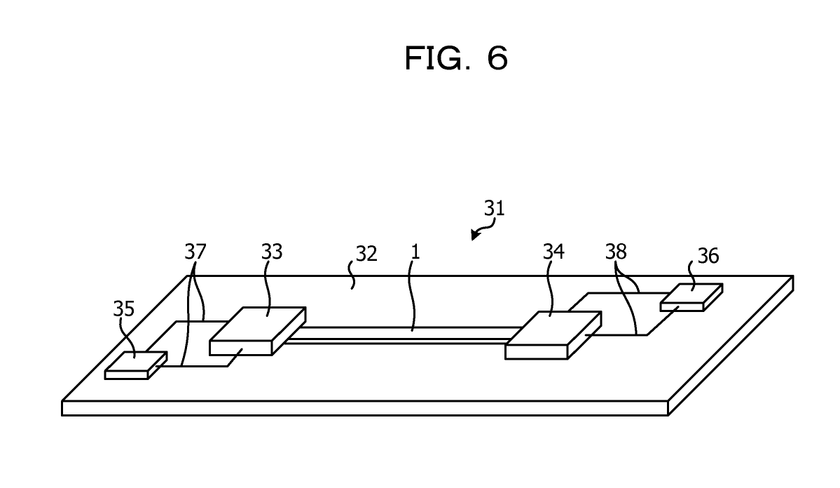

FIG. 6 is a diagram illustrating an example of a photoelectric hybrid board according to an embodiment. As illustrated in FIG. 6, a photoelectric hybrid board 31 includes an optical waveguide 1, an electrical board 32, an electrical-to-optical conversion device 33, an optical-to-electrical conversion device 34, electrical parts 35 and 36, and electrical interconnections 37 and 38. The optical waveguide 1, the electrical-to-optical conversion device 33, the optical-to-electrical conversion device 34, and the electrical parts 35 and 36 are mounted on the electrical board 32. The electrical interconnections 37 and 38 are formed in the electrical board 32. In other words, the electrical board 32 is a printed wiring board.

The electrical part 35 is an integrated circuit (IC) chip such as a large scale integration (LSI), and generates an electrical signal based on transmitted data. The electrical part 35 and the electrical-to-optical conversion device 33 are electrically connected to each other by the electrical interconnections 37. The electrical signal generated by the electrical part 35 is given to the electrical-to-optical conversion device 33 through the electrical interconnections 37.

The electrical-to-optical conversion device 33 is electrically connected to the light incident-side end surface of the optical waveguide 1. The electrical-to-optical conversion device 33 includes a light-emitting element, converts the electrical signal given from the electrical part 35 into an optical signal by using the light-emitting element, and causes the optical signal to enter the optical waveguide 1. The optical waveguide 1 is one of the optical waveguides 1 illustrated respectively in FIGS. 1 to 4.

The optical-to-electrical conversion device 34 is electrically connected to the light outgoing-side end surface of the optical waveguides 1. The optical-to-electrical conversion device 34 includes a light-receiving element, receives the signal light emitted from the optical waveguides 1 by using the light-receiving element, and converts the signal light into an electrical signal.

The optical-to-electrical conversion device 34 and the electrical part 36 are electrically connected to each other by the electrical interconnections 38. The electrical signal outputted from the optical-to-electrical conversion device 34 is given to the electrical part 36 through the electrical interconnections 38. The electrical part 36 is, for example, an IC chip such as an LSI, and generates received data based on the electrical signal given from the optical-to-electrical conversion device 34.

The printed wiring board unit may be a unit which includes the photoelectric hybrid board 31, for example, housed in a housing. The housing may be provided with connectors to be used to connect the photoelectric hybrid board 31 to other printed wiring boards and other units.

In the photoelectric hybrid board 31 illustrated in FIG. 6 and the printed wiring board unit including the photoelectric hybrid board 31, no lower-order mode of signal light reaches the optical-to-electrical conversion device 34. Since the optical-to-electrical conversion device 34 receives a higher-order mode of signal light, and converts the higher-order mode of signal light into an electrical signal, the optical-to-electrical conversion device 34 is capable of suppressing the occurrence of jitters, and accordingly deterioration in the signal quality.

In Examples 1 to 3, the second cladding 4 optically closes the central part of the core in the direction perpendicular to the direction of the propagation of the light. Furthermore, the reduction of the propagation of a lower-order mode of light may be achieved by optically closing the center of the light source 10 or the center of the optical-to-electrical conversion device 34 with the second cladding 4.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical waveguide comprising:
a core through which light propagates;
a first cladding covering a periphery of the core; and
a second cladding optically closing part of the core in a direction perpendicular to a direction of the propagation of the light.

2. The optical waveguide according to claim 1,
wherein the core, the first cladding, and the second cladding are formed from an epoxy-based resin.

3. The optical waveguide according to claim 2,
wherein a refractive index of the core is higher than refractive indices of the first cladding and the second cladding.

4. The optical waveguide according to claim 1,
wherein the second cladding is provided in a central part of the core close to a light incident side.

5. The optical waveguide according to claim 1,
wherein the second cladding is provided in a central part of the core close to a light outgoing side.

6. The optical waveguide according to claim 1,
wherein the second cladding is provided in a central part of the core for a full length of the core in the direction of the propagation of the light.

7. A photoelectric hybrid board comprising:
a board including an electrical part and interconnections;
an electrical-to-optical conversion device mounted on the board, and configured to convert an electrical signal received from the electrical part into an optical signal;
an optical waveguide mounted on the board, and configured to guide the optical signal outputted from the electrical-to-optical conversion device;
an optical-to-electrical conversion device mounted on the board, and configured to convert the optical signal outputted from the optical waveguide into an electrical signal, wherein
the optical waveguide includes;
a core through which the optical signal propagates;
a first cladding covering a periphery of the core; and
a second cladding optically closing a central portion of the electrical-to-optical conversion device.

8. A method of manufacturing an optical waveguide,
the optical waveguide including
a core through which light propagates
a first cladding covering a periphery of the core, and
a second cladding optically closing part of the core in a direction perpendicular to a direction of the propagation of the light,
the method comprising:
forming a first layer on a substrate;
forming a second layer on the first layer;
removing part of the second layer to form part of the core;
forming a third layer on the first layer and on the part of the core;
removing the third layer from top of the first layer such that the third layer remains on the part of the core, to form the second cladding;
forming a fourth layer on the first layer and the second cladding;
removing the fourth layer from top of the first layer such that the fourth layer remains on the second cladding, and at two sides of the second cladding, to form the core;
forming a fifth layer on the first layer and the core; and
removing the fifth layer from top of the first layer such that the fifth layer remains on the core.
